(19) United States
(12) Patent Application Publication
(10) Pub. No.: US 2025/0139527 A1
(43) Pub. Date: May 1, 2025

(54) SELF-IMPROVING MODELS FOR AGENTIC VISUAL PROGRAM SYNTHESIS

(71) Applicant: NEC Laboratories America, Inc., Princeton, NJ (US)

(72) Inventors: Vijay Kumar Baikampady Gopalkrishna, Santa Clara, CA (US); Samuel Schulter, Long Island City, NY (US); Manmohan Chandraker, Santa Clara, CA (US); Zaid Khan, Cambridge, MA (US)

(21) Appl. No.: 18/930,402

(22) Filed: Oct. 29, 2024

Related U.S. Application Data
(60) Provisional application No. 63/595,082, filed on Nov. 1, 2023.
(60) Provisional application No. 63/599,530, filed on Nov. 15, 2023.

(51) Int. Cl. G06N 20/00

(52) U.S. Cl. CPC G06N 20/00

(57) ABSTRACT

Systems and methods for a self-improving model for agentic visual program synthesis. An agent can be continuously trained using an optimal training tuple to perform a corrective action to a monitored entity which in turn generates new input data for the training. To train the agent, an input question can be decomposed into vision model tasks to generate task outputs. The task outputs can be corrected based on feedback to obtain corrected task outputs. The optimal training tuple can be generated by comparing an optimal tuple threshold with a similarity score of the input image, the input question, and the corrected task outputs.

### RELATED APPLICATION INFORMATION

This application claims priority to U.S. Provisional App. No. 63/595,082, filed on Nov. 1, 2023; U.S. Provisional App. No. 63/599,530, filed on Nov. 15, 2023, incorporated herein by reference in their entirety.

### BACKGROUND

### Technical Field

The present invention relates to training machine learning models and more particularly to self-improving models for agentic visual program synthesis.

### Description of the Related Art

Artificial intelligence (AI) models have improved dramatically over the years especially in entity detection, scene reconstruction, anomaly detection, trajectory generation, and scene understanding. However, training AI models is time and resource intensive. Additionally, the accuracy of the outputs of the AI models is directly proportional to the utility of the Al models. Alleviating such drawbacks is still a persistent challenge in the realm of artificial intelligence.

### SUMMARY

According to an aspect of the present invention, a computer-implemented method is provided for training a self-improving model for agentic visual program synthesis, including, decomposing an input question into vision model tasks to generate task outputs using an agent, correcting task outputs based on feedback to obtain corrected task outputs, generating an optimal training tuple by comparing an optimal tuple threshold with a similarity score of an input image, the input question, and the corrected task outputs, training the agent continuously using the optimal training tuple to obtain a trained agent, and performing a corrective action to a monitored entity using the trained agent and input sensors to obtain new training data for the training.

According to another aspect of the present invention, a system is provided for a self-improving model for agentic visual program synthesis, including: a memory device, one or more processor devices operatively coupled with the memory device to decompose an input question into vision model tasks to generate task outputs using an agent, correct task outputs based on feedback to obtain corrected task outputs, generate an optimal training tuple by comparing an optimal tuple threshold with a similarity score of an input image, the input question, and the corrected task outputs, train the agent continuously using the optimal training tuple to obtain a trained agent, and perform a corrective action to a monitored entity using the trained agent and input sensors to obtain new training data for the training.

According to yet another aspect of the present invention, a non-transitory computer program product including a computer-readable storage medium having program code for a self-improving model is provided for agentic visual program synthesis, wherein the program code when executed on a computer causes the computer to: decompose an input question into vision model tasks to generate task outputs using an agent, correct task outputs based on feedback to obtain corrected task outputs, generate an optimal training tuple by comparing an optimal tuple threshold with a similarity score of an input image, the input question, and the corrected task outputs, train the agent continuously using the optimal training tuple to obtain a trained agent, and perform a corrective action to a monitored entity using the trained agent and input sensors to obtain new training data for the training.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a flow diagram illustrating a high-level overview of a computer-implemented method for training a self-improving model for agentic visual program synthesis, in accordance with an embodiment of the present invention;

FIG. 2 is a block diagram illustrating a system for a self-improving model for agentic visual program synthesis, in accordance with an embodiment of the present invention; and

FIG. 3 is a flow diagram illustrating a software implementation of a self-improving model for agentic visual program synthesis, in accordance with an embodiment of the present invention;

FIG. 4 is a block diagram illustrating a system that implements a practical application of the self-improving model for agentic visual program synthesis, in accordance with an embodiment of the present invention; and

FIG. 5 is a block diagram illustrating deep learning neural networks for a self-improving model for agentic visual program synthesis, in accordance with an embodiment of the present invention.

### DETAILED DESCRIPTION OF PREFERRED EMBODIMENTS

In accordance with embodiments of the present invention, systems and methods are provided for self-improving models for agentic visual program synthesis.

In an embodiment, an agent can be continuously trained using an optimal training tuple to perform a corrective action to a monitored entity which in turn generates new input data for the training. To train the agent, an input question can be decomposed into vision model tasks to generate task outputs. The task outputs can be corrected based on feedback to obtain corrected task outputs. The optimal training tuple can be generated by comparing an optimal tuple threshold with a similarity score of an input image, the input question, and the corrected task outputs.

Agentic visual program synthesis is a promising approach for solving reasoning tasks where a high-level task such as, human instruction for domain-specific tasks (e.g., object detection, image retrieval, anomaly detection, etc.) is decomposed into a sequence of smaller tasks (or code) which are executed by task-specific computer vision modules. To train such large language model (LLM)-based agent efficiently, a large dataset of visual programs is crucial, however, the requirement for specialized annotations makes securing such a dataset difficult.

Previous techniques employ an API-only, LLM (frozen) with over 100 B parameters for synthesizing visual programs, primarily due to the absence of a dedicated training dataset, however reliance on these external agents presents at least the following challenges:
Privacy risks. The data or instructions are routed to an external API which can pose security risks.
Efficacy. The agent's domain-specific language knowledge that is confined to in-context examples or APIs which can hinder efficacy as in-context examples or APIs are limited to their context and would have difficulty transferring such knowledge to real-world data.
Scalability. As computer vision modules grow rapidly, the size of the model grows proportional to the size of the modules which hinders its scalability.

The present embodiments address these limitations by training an agentic LLM with continuous learning using feedback that corrects identified mistakes. Every sample in this dataset is a tuple made up of an image, high-level questions, and an answer. Our agentic model breaks down the main (visual) question into smaller tasks, which are then processed by computer vision modules. The present embodiments introduce a unique self-training approach where the agent continually refines itself using feedback from the user. After each self-training phase, the user provides (a few) new code examples highlighting areas where the agent made a mistake. Through this iterative process of identifying and rectifying mistakes, the agent's performance improves. The knowledge learned by training from such weak supervision can be transferred to other tasks such as object detection, image retrieval, etc

The present embodiments provide a training framework that trains an adaptable, accurate, scalable agent that improves itself continuously with feedback and new input data. The trained agent can be adapted to domain-specific tasks such as object detection, image retrieval, anomaly detection, trajectory generation, etc.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer-readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid-state memory, magnetic tape, a removable computer diskette, a random-access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

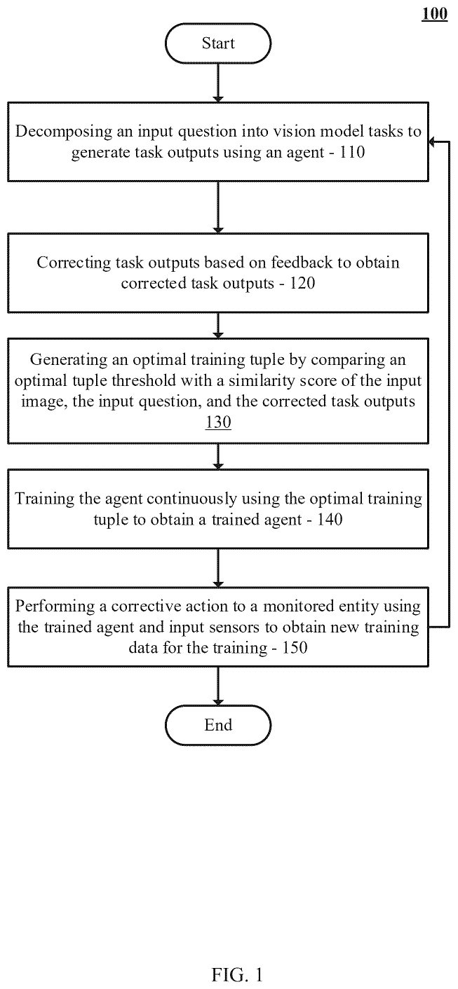

Referring now in detail to the figures in which like numerals represent the same or similar elements and initially to FIG. 1, a high-level overview of a computer-implemented method for a self-improving model for agentic visual program synthesis is illustratively depicted in accordance with one embodiment of the present invention.

In an embodiment, an agent can be continuously trained using an optimal training tuple to perform a corrective action to a monitored entity which in turn generates new input data for the training. To train the agent, an input question can be decomposed into vision model tasks to generate task outputs. The task outputs can be corrected based on feedback to obtain corrected task outputs. The optimal training tuple can be generated by comparing an optimal tuple threshold with a similarity score of an input image, the input question, and the corrected task outputs. Referring now to block 110 of FIG. 1 showing an embodiment of a method of decomposing an input question into vision model tasks to generate task outputs using an agent.

The input question can be a series of text that is relevant to an input image. The input questions can be based on semantic information of the input image such as counting, reasoning, external knowledge, etc. For example, an input question for an input image containing a dog can be “does the dog have black ears?” In an embodiment, the input question can be obtained from a question-answering (QA) dataset such as generalized question answering (GQA), visual question answering (VQA). In another embodiment, the input question, input image, and task outputs can be supplied by a user. The QA dataset can include tuples of an image, question and a task output. After training, sensors can provide the input question, input image and task outputs from real-world data. The sensors can include a camera, microphone, text processor, etc.

The vision model tasks can include object detection and identification, attribute detection, spatial relationship detection, and logical and comparative reasoning. In the previous example, the corresponding image of the dog can be processed by the agent (e.g., vision model) by learning object data from the input image to corresponding texts from the input question. Object data can include object classes, relationships between objects and attributes of the objects. To learn the object data, the class of the object, attributes, spatial relationship and comparative logic can be identified. The agent can detect the object with the classifier “dog” by using previously learned classifiers (e.g., entity labels such as dog, horse, cat, house, etc.) from a known dataset (e.g., ground truth data from a dataset) and their corresponding images. The agent can also detect the attributes of the dog such as color, size, etc. by using previously learned attribute classifiers (e.g., color, specific body parts of entities, etc.). The agent can also perform comparative reasoning to identify whether the attribute of the object detected as the dog's ears are black by using previously learned classifiers with comparative logic.

The task outputs can be the answer to the input question that includes the relevant object, attributes, spatial relationship and comparative reasoning result for the input question. In the previous example, the task output can include the bounding box of the dog, the dog's ears, identified attributes of the dog such as color, size, and an answer text stating “yes, the dog's ears are black.” The task output can include a mapping of identified objects, identified relationships between objects, and identified attributes of the objects from the input image into corresponding labels texts from the input question.

The agent can be a vision-question-answering model that can combine computer vision tasks and natural language processing. The agent can be a multimodal co-attention network (MCAN), bilinear attention network (BAN), transformer-based models such as VQA transformer.

Referring now to block 120 of FIG. 1 showing an embodiment of a method of correcting task outputs based on feedback to obtain corrected task outputs.

Mistakes from the task outputs can be identified based on feedback. The agent can provide probability scores of the object data (e.g., class of object, attributes of object, bounding box, etc.) from the task output that it generated from the input question, corresponding image. The agent can compute the probability scores by computing the difference of the semantic relationships of tokens (e.g., cosine similarity) between feedback and the task outputs. Feedback can be obtained from ground truth data from the input dataset. In another embodiment, feedback can be generated by an expert that includes a pre-trained model, an expert user, etc. If the probability score is below a mistake threshold, then it is considered a mistake. The mistake threshold can be a predefined number ranging from zero to one such as 0.70.

The task outputs and their corresponding input questions and images can be clustered based on the similarity of their computed mistake. The clustering algorithm can be k-means clustering. The clusters having the lowest probability score of accuracy provided can be selected to be corrected.

To correct the task outputs, the model trainer can learn the mistakes of the agent based on the feedback. The corrected task output can be new code examples that can highlight the areas where the agent made a mistake. The corrected task outputs can include bounding box that highlights the mistake, and a textual description of the mistake. The model trainer can learn the mistakes of the agent by learning the semantics between the input question, the input images, and the corrected task output. The semantics can include counting, reasoning, external knowledge, etc. For example, in the previous example, if the agent detected that the color of the dog's ears are navy instead of black, the code example can include that the dog's ears are black instead of navy. The code example for the dog's ears can then be employed as external knowledge that can be stored in the knowledge of the model trainer. The model trainer can include a vision-question-answering model that can combine computer vision tasks and natural language processing. The model trainer can include a multimodal co-attention network (MCAN), bilinear attention network (BAN), transformer-based models such as VQA transformer.

After some training iterations, the model trainer can generate the corrected task outputs from previously used corrected task outputs. If the generated corrected task outputs are above the mistake threshold, then the generated corrected task outputs will be used as the corrected task outputs.

Referring now to block 130 of FIG. 1 showing an embodiment of a method of generating an optimal training tuple by comparing an optimal tuple threshold with a similarity score of an input image, the input question, and the corrected task outputs.

The optimal training tuple can be a packaged code that includes an input image, input question and the corrected task outputs that can be processed by the agent. The optimal training tuple can be generated by the model trainer. In another embodiment, the optimal training tuple is sent to the model trainer located a different physical location from the agent to train the agent that is connected through a network.

In an embodiment, an optimal tuple threshold can be used to determine whether the input question, input image is similar to the corrected task output. The optimal tuple threshold can be a predefined number ranging from zero to one, such as 0.9. The similarity score of the input image, input question, and corrected task output can be determined by a pre-trained visual question-answering model. If the similarity score of the input image, input question, and corrected task output is greater than or equal to the optimal tuple threshold, then such combination will be included in the optimal training tuple.

In another embodiment, based on the learned semantics of the model trainer, the model trainer can automatically select the optimal training tuple that includes an input image, the input question, and the corrected task outputs. By using the optimal training tuple, training the model would be more efficient as the optimal training tuple would avoid combinations that would likely produce mistakes.

Referring now to block 140 of FIG. 1 showing an embodiment of a method of training the agent continuously using the optimal training tuple to obtain a trained agent.

The agent can be continuously trained using the optimal training tuple to obtain a trained agent. The agent can retain its previously learned knowledge while learn new information with the optimal training tuple. To train the agent, a loss function between the task outputs and the corrected task outputs can be minimized. The loss function can include bounding box regression and cross entropy loss.

To retain its previously learned knowledge, the agent can apply regularization such as elastic weight consolidation (EWC) to penalize changes to important parameters for previously learned tasks. The agent's performance improves after every iteration of training. Additionally, the model trainer can also learn how the agent makes mistakes, and how to generate the optimal training tuple based on past iterations.

Referring now to block 150 of FIG. 1 showing an embodiment of a method of performing a corrective action to an entity using the trained agent to obtain new training data to continuously train the trained agent.

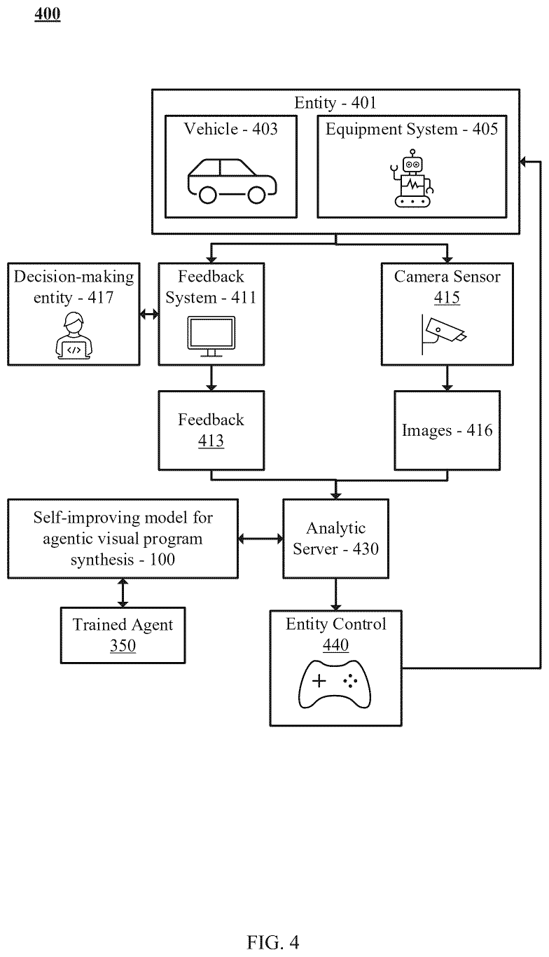

The monitored entity can be a vehicle, a monitored equipment system, etc. The corrective action can be controlling the monitored entity. This is shown in more detail in FIG. 4.

Referring now to FIG. 4 showing an embodiment of a system that implements a practical application of the self-improving model for agentic visual program synthesis.

The system 400 can perform a corrective action to a monitored entity 401. The monitored entity 401 can be a vehicle 403, a monitored equipment system 405, etc.

The monitored entity 401 can have an input sensor (e.g., camera sensor 415, microphone, etc.) that can capture input data (e.g., images 416, audio, text, etc.). The monitored entity can be communicated with a feedback system 411 that obtains feedback 413 from a decision-making entity 417. The feedback system 411 can include a display to show a feedback query to the decision-making entity 417 and an input interface (e.g., touch, typing interface, microphone, etc.) to allow the decision-making entity 417 to provide inputs responsive to the feedback query.

The feedback 413 and the images 416 can be sent to the analytic server 430 that implements the self-improving model for agentic visual program synthesis 100. The analytic server 430 can also host the trained agent 350. The trained agent 350 can be employed to perform downstream tasks such as entity control 440.

Entity control 440 for the vehicle 403 can include controlling the vehicle 403 such as braking, speeding up, changing direction, etc. based on a trajectory generated by the trained agent 350 from an input image 416 through an advanced driver assistance system (ADAS). Entity control 440 for the equipment system 405 can include rerouting products that do not belong to its current workflow (e.g., redirecting red gloves from a green gloves workflow to the red gloves workflow), halting the equipment system 405 responsive to a detected critical threshold (e.g., temperature, product threshold, etc.), etc.

In another embodiment, the analytic server 430 can also perform question answering based on the input image 416 and input question. For example, in the vehicle context, the input image can be the traffic scene, and the input question can be “How many cars are in front of me and on my adjacent lanes?”, and the analytic server 430 can answer depending on the detected cars that are in front of the vehicle. Other practical applications are contemplated.

The present embodiments provide a training framework that trains an adaptable, accurate, scalable agent that improves itself continuously with feedback and new input data. The trained agent can be adapted to domain-specific tasks such as object detection, image retrieval, anomaly detection, trajectory generation, etc.

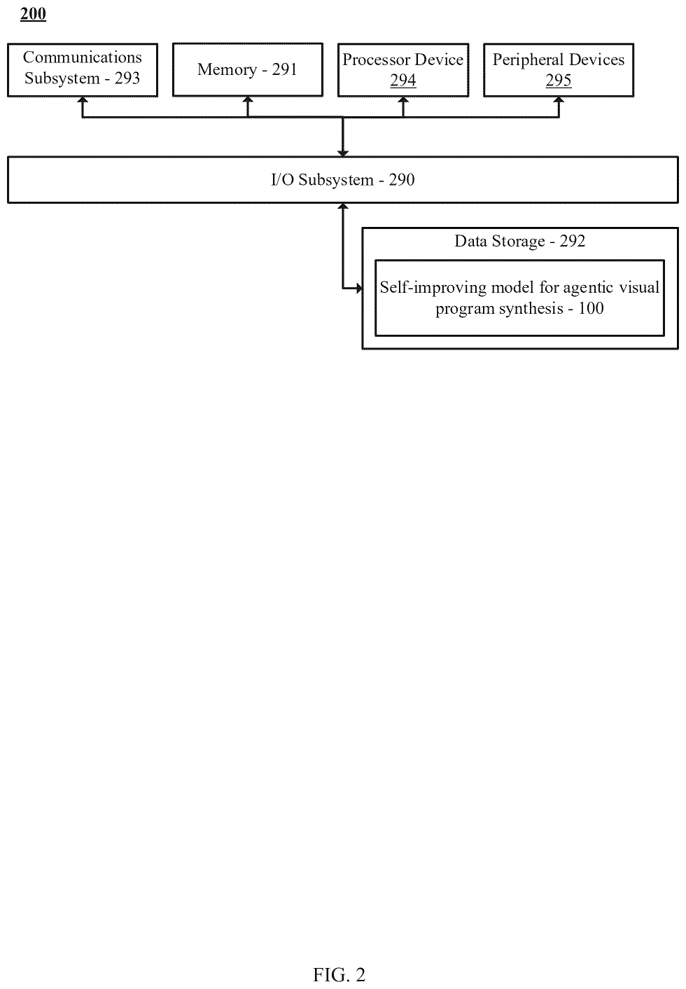

Referring now to FIG. 2, a system for a self-improving model for agentic visual program synthesis is illustratively depicted in accordance with an embodiment of the present invention.

The computing device 200 illustratively includes the processor device 294, an input/output (I/O) subsystem 290, a memory 291, a data storage device 292, and a communication subsystem 293, and/or other components and devices commonly found in a server or similar computing device. The computing device 200 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 291, or portions thereof, may be incorporated in the processor device 294 in some embodiments.

The processor device 294 may be embodied as any type of processor capable of performing the functions described herein. The processor device 294 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 291 may be embodied as any type of volatile or non-volatile memory or data storage capable of performing the functions described herein. In operation, the memory 291 may store various data and software employed during operation of the computing device 200, such as operating systems, applications, programs, libraries, and drivers. The memory 291 is communicatively coupled to the processor device 294 via the I/O subsystem 290, which may be embodied as circuitry and/or components to facilitate input/output operations with the processor device 294, the memory 291, and other components of the computing device 200. For example, the I/O subsystem 290 may be embodied as, or otherwise include, memory controller hubs, input/output control hubs, platform controller hubs, integrated control circuitry, firmware devices, communication links (e.g., point-to-point links, bus links, wires, cables, light guides, printed circuit board traces, etc.), and/or other components and subsystems to facilitate the input/output operations. In some embodiments, the I/O subsystem 290 may form a portion of a system-on-a-chip (SOC) and be incorporated, along with the processor device 294, the memory 291, and other components of the computing device 200, on a single integrated circuit chip.

The data storage device 292 may be embodied as any type of device or devices configured for short-term or long-term storage of data such as, for example, memory devices and circuits, memory cards, hard disk drives, solid state drives, or other data storage devices. The data storage device 292 can store program code a self-improving model for agentic visual program synthesis 100. Any or all of these program code blocks may be included in a given computing system.

The communication subsystem 293 of the computing device 200 may be embodied as any network interface controller or other communication circuit, device, or collection thereof, capable of enabling communications between the computing device 200 and other remote devices over a network. The communication subsystem 293 may be configured to employ any one or more communication technology (e.g., wired or wireless communications) and associated protocols (e.g., Ethernet, InfiniBand®, Bluetooth®, Wi-Fi®, WiMAX, etc.) to affect such communication.

As shown, the computing device 200 may also include one or more peripheral devices 295. The peripheral devices 295 may include any number of additional input/output devices, interface devices, and/or other peripheral devices. For example, in some embodiments, the peripheral devices 295 may include a display, touch screen, graphics circuitry, keyboard, mouse, speaker system, microphone, network interface, and/or other input/output devices, interface devices, GPS, camera, and/or other peripheral devices.

Of course, the computing device 200 may also include other elements (not shown), as readily contemplated by one of skill in the art, as well as omit certain elements. For example, various other sensors, input devices, and/or output devices can be included in computing device 200, depending upon the particular implementation of the same, as readily understood by one of ordinary skill in the art. For example, various types of wireless and/or wired input and/or output devices can be employed. Moreover, additional processors, controllers, memories, and so forth, in various configurations can also be utilized. These and other variations of the computing system 200 are readily contemplated by one of ordinary skill in the art given the teachings of the present invention provided herein.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result. In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

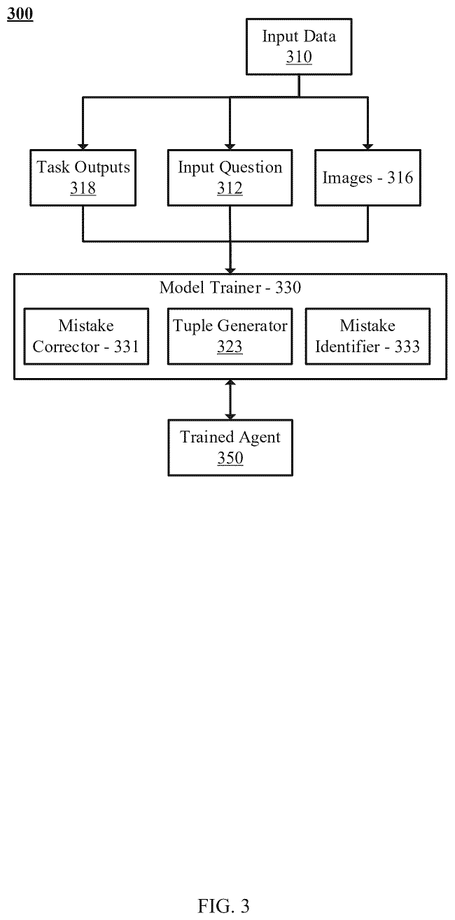

Referring now to FIG. 3, showing a system showing a software implementation of a self-improving model for agentic visual program synthesis, in accordance with an embodiment of the present invention.

In an embodiment, input data 310 can include the input question 312, image 316, and task output 318. The model trainer 330 can train the agent using the optimal training tuple to obtain a trained agent 350. The model trainer 330 can include the mistake corrector 331, the mistake identifier 333, and the tuple generator 323. The mistake corrector 331 can correct the mistake of the trained agent 350 based on the mistake identified from the task output of the trained agent 350 by the mistake identifier 333 of the model trainer 330 to obtain corrected task outputs. The tuple generator 323 can generate the optimal training tuple including the input question 312, image 316, and task output 318. The tuple generator 323 can then generate a new optimal training tuple from the corrected task output, the input image, and the input question to train the trained agent 350. During inference, new input data 310 can be obtained from real-world data using sensors, a dataset, or from experts.

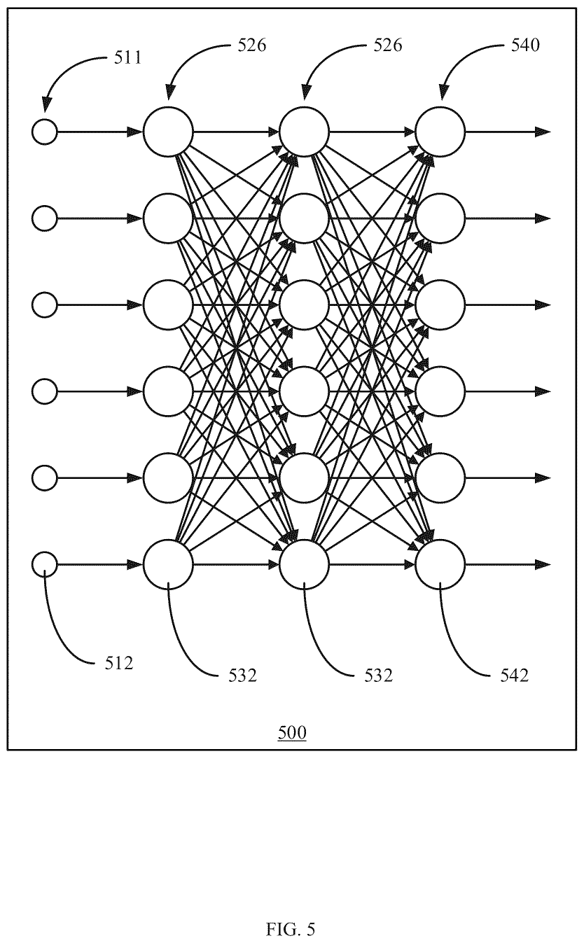

Referring now to FIG. 5, a block diagram illustrating deep learning neural networks for a self-improving model for agentic visual program synthesis, in accordance with an embodiment of the present invention.

A neural network is a generalized system that improves its functioning and accuracy through exposure to additional empirical data. The neural network becomes trained by exposure to the empirical data. During training, the neural network stores and adjusts a plurality of weights that are applied to the incoming empirical data. By applying the adjusted weights to the data, the data can be identified as belonging to a particular predefined class from a set of classes or a probability that the inputted data belongs to each of the classes can be output.

The empirical data, also known as training data, from a set of examples can be formatted as a string of values and fed into the input of the neural network. Each example may be associated with a known result or output. Each example can be represented as a pair, (x, y), where x represents the input data and y represents the known output. The input data may include a variety of different data types and may include multiple distinct values. The network can have one input neurons for each value making up the example's input data, and a separate weight can be applied to each input value. The input data can, for example, be formatted as a vector, an array, or a string depending on the architecture of the neural network being constructed and trained.

The neural network “learns” by comparing the neural network output generated from the input data to the known values of the examples and adjusting the stored weights to minimize the differences between the output values and the known values. The adjustments may be made to the stored weights through back propagation, where the effect of the weights on the output values may be determined by calculating the mathematical gradient and adjusting the weights in a manner that shifts the output towards a minimum difference. This optimization, referred to as a gradient descent approach, is a non-limiting example of how training may be performed. A subset of examples with known values that were not used for training can be used to test and validate the accuracy of the neural network.

During operation, the trained neural network can be used on new data that was not previously used in training or validation through generalization. The adjusted weights of the neural network can be applied to the new data, where the weights estimate a function developed from the training examples. The parameters of the estimated function which are captured by the weights are based on statistical inference.

The deep neural network 500, such as a multilayer perceptron, can have an input layer 511 of source neurons 512, one or more computation layer(s) 526 having one or more computation neurons 532, and an output layer 540, where there is a single output neuron 542 for each possible category into which the input example could be classified. An input layer 511 can have a number of source neurons 512 equal to the number of data values 512 in the input data 511. The computation neurons 532 in the computation layer(s) 526 can also be referred to as hidden layers, because they are between the source neurons 512 and output neuron(s) 542 and are not directly observed. Each neuron 532, 542 in a computation layer generates a linear combination of weighted values from the values output from the neurons in a previous layer, and applies a non-linear activation function that is differentiable over the range of the linear combination. The weights applied to the value from each previous neuron can be denoted, for example, by w₁, w₂, . . . wₙ₋₁, wₙ. The output layer provides the overall response of the network to the inputted data. A deep neural network can be fully connected, where each neuron in a computational layer is connected to all other neurons in the previous layer, or may have other configurations of connections between layers. If links between neurons are missing, the network is referred to as partially connected.

In an embodiment, the computation layers 526 of model trainer 330 and trained agent 350 can learn relationships between bounding boxes of an input image 316 with ground truth bounding boxes. The output layer 540 of the model trainer 330 and trained agent 350 can then provide the overall response of the network as a likelihood score of the bounding box and a correct label of a category of an object within the input image 316. In an embodiment, the computation layers 526 of model trainer 330 and trained agent 350 can learn relationships between task outputs 318 with object attributes from a detected object from an input image. The output layer 540 of the model trainer 330 and trained agent 350 can then provide the overall response of the network as a similarity score of task output 318 and the object attributes of the object within the input image 316. In another embodiment, the trained agent 350 can be employed to generate trajectories for a vehicle based on a traffic scene simulated from input images 316. In another embodiment, the trained agent 350 can be employed to detect anomalies from an input image 316.

Training a deep neural network can involve two phases, a forward phase where the weights of each neuron are fixed and the input propagates through the network, and a backwards phase where an error value is propagated backwards through the network and weight values are updated. The computation neurons 532 in the one or more computation (hidden) layer(s) 526 perform a nonlinear transformation on the input data 512 that generates a feature space. The classes or categories may be more easily separated in the feature space than in the original data space.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws.

What is claimed and desired protected by Letters Patent is set forth in the appended claims:

1. A computer-implemented method for training a self-improving model for agentic visual program synthesis, comprising:
decomposing an input question into vision model tasks to generate task outputs using an agent;
correcting task outputs based on feedback to obtain corrected task outputs;
generating an optimal training tuple by comparing an optimal tuple threshold with a similarity score of an input image, the input question, and the corrected task outputs;
training the agent continuously using the optimal training tuple to obtain a trained agent; and
performing a corrective action to a monitored entity using the trained agent and input sensors to obtain new training data for the training.

2. The computer-implemented method of claim 1, wherein performing the corrective action further comprises controlling a vehicle based on a trajectory generated from an input image using the trained agent.

3. The computer-implemented method of claim 1, wherein decomposing the input question further comprises learning object data from the input image to corresponding texts from the input question.

4. The computer-implemented method of claim 3, wherein learning the object data further comprises mapping identified objects, identified relationships between objects, and identified attributes of the objects from the input image into corresponding labels texts from the input question.

5. The computer-implemented method of claim 1, wherein correcting the task outputs further comprises identifying mistakes from the task outputs based on the feedback.

6. The computer-implemented method of claim 5, wherein identifying the mistakes further comprises learning semantic relationships between tokens from the task outputs and the feedback.

7. The computer-implemented method of claim 5, wherein correcting the task outputs further comprises clustering embeddings of corresponding pairs of task outputs and input questions based on an identified number of mistakes.

8. A system for a self-improving model for agentic visual program synthesis, comprising:
a memory device;
one or more processor devices operatively coupled with the memory device to:
decompose an input question into vision model tasks to generate task outputs using an agent;
correct task outputs based on feedback to obtain corrected task outputs;
generate an optimal training tuple by comparing an optimal tuple threshold with a similarity score of an input image, the input question, and the corrected task outputs;
train the agent continuously using the optimal training tuple to obtain a trained agent; and
perform a corrective action to a monitored entity using the trained agent and input sensors to obtain new training data for the training.

9. The system of claim 8, wherein to perform the corrective action further comprises to control a vehicle based on a trajectory generated from an input image using the trained agent.

10. The system of claim 8, wherein to decompose the input question further comprises to learn object data from the input image to corresponding texts from the input question.

11. The system of claim 10, wherein to learn the object data further comprises mapping identified objects, identified relationships between objects, and identified attributes of the objects from the input image into corresponding labels texts from the input question.

12. The system of claim 8, wherein to correct the task outputs further comprises to identify mistakes from the task outputs based on the feedback.

13. The system of claim 12, wherein to identify the mistakes further comprises learning semantic relationships between tokens from the task outputs and the feedback.

14. The system of claim 12, wherein to correct the task outputs further comprises clustering embeddings of corresponding pairs of task outputs and input questions based on an identified number of mistakes.

15. A non-transitory computer program product comprising a computer-readable storage medium including program code for a self-improving model for agentic visual program synthesis, wherein the program code when executed on a computer causes the computer to:
decompose an input question into vision model tasks to generate task outputs using an agent;
correct task outputs based on feedback to obtain corrected task outputs;
generate an optimal training tuple by comparing an optimal tuple threshold with a similarity score of an input image, the input question, and the corrected task outputs;
train the agent continuously using the optimal training tuple to obtain a trained agent; and
perform a corrective action to a monitored entity using the trained agent and input sensors to obtain new training data for the training.

16. The non-transitory computer program product of claim 15, wherein to perform a corrective action further comprises to control a vehicle based on a trajectory generated from an input image using the trained agent.

17. The non-transitory computer program product of claim 15, wherein to decompose the input question further comprises to learn object data from the input image to corresponding texts from the input question.

18. The non-transitory computer program product of claim 17, wherein to learn the object data further comprises mapping identified objects, identified relationships between objects, and identified attributes of the objects from the input image into corresponding labels texts from the input question.

19. The non-transitory computer program product of claim 15, wherein to correct the task outputs further comprises to identify mistakes from the task outputs based on the feedback by learning semantic relationships between tokens from the task outputs and the feedback.

20. The non-transitory computer program product of claim 19, wherein to correct the task outputs further comprises clustering embeddings of corresponding pairs of task outputs and input questions based on an identified number of mistakes.
